(19) United States
(12) Patent Application Publication
(10) Pub. No.: US 2020/0190869 A1
(43) Pub. Date: Jun. 18, 2020

(54) AUTOMATIC VULNERABLE OBJECT DETECTION TRIGGERED HOOD LATCH RELEASE

(71) Applicant: GM Global Technology Operations LLC, Detroit, MI (US)

(72) Inventors: Rathan H. P, Karnataka (IN); Vivekananda Kinila, Karnataka (IN)

(73) Assignee: GM Global Technology Operations LLC, Detroit, MI (US)

(21) Appl. No.: 16/220,858

(22) Filed: Dec. 14, 2018

(51) Int. Cl. E05B 81/64; E05B 83/24; E05B 77/08; E05B 85/04

(52) U.S. Cl. CPC E05B 81/64; E05B 85/04; E05B 77/08; E05B 83/24

(57) ABSTRACT

A vehicle includes a hood panel configured to cover the vehicle's under-hood compartment. The vehicle also includes a mechanism for selectively fastening the hood panel to the vehicle body and maintaining the compartment's closure in a first position and maintaining the hood panel within a predetermined distance from the vehicle body in a second position. The vehicle additionally includes a release system for releasing the hood from the first to the second position via the mechanism. The release system includes a sensor arrangement for detecting the presence of a vulnerable object in the vehicle path, and a controller for ascertaining whether the vehicle is in motion. The controller is also configured to trigger the mechanism, in response to a signal from the sensor arrangement indicative of the detected presence of the object, to release the hood panel from the first to the second position when the vehicle is in motion.

### INTRODUCTION

The disclosure relates to automatic vulnerable object detection triggered release of a motor vehicle hood latch.

In motor vehicles, a hood or bonnet is a moveable, typically hinged, panel configured to selectively cover and permit access to a compartment defined by the vehicle body. In vehicles with a front-mounted power-plant, the hood permits access to the power-plant for maintenance and repair. In vehicles with a rear-mounted power-plant, and in some vehicles with a mid-mounted power-plant, the hood covers a main storage compartment or trunk.

Commonly, a vehicle hood is held down by a concealed latch. Such a latch is generally designed to protect the vehicle or the compartment contents from theft, damage, and sudden opening of the hood while the vehicle is in motion. A hood release system is common on vehicles, and typically includes an interior compartment hood latch handle, a hood release cable, and a hood latch assembly. The hood latch handle is usually located for convenient access by the vehicle's operator. In such systems, when the hood latch handle is pulled, the release cable actuates the hood latch assembly, thus permitting the hood panel to be opened for access to the covered compartment.

### SUMMARY

A vehicle includes a vehicle body defining a compartment and a hood panel configured to cover the compartment and thereby define an under-hood compartment. The vehicle also includes a mechanism configured to selectively fasten the hood panel to the vehicle body such that the hood panel maintains closure of the compartment in a first hood position and maintains the hood panel within a predetermined distance from the vehicle body in a second hood position. The vehicle additionally includes a release system configured to regulate the mechanism to release the hood panel from the first hood position to the second hood position. The release system includes an electronic controller and a sensor arrangement configured to detect the presence of a vulnerable object in a path of the vehicle. The electronic controller is configured to ascertain whether the vehicle is in motion and receive from the sensor arrangement a signal indicative of the detected presence of a vulnerable object. The electronic controller is further configured to trigger the mechanism, in response to the signal, to release the hood panel from the first hood position to the second hood position when the vehicle is in motion. Such a release of the hood panel to the second hood position is intended to reduce a magnitude of forces on the vulnerable object in the event the object impacts the vehicle in the area of the hood panel.

The sensor arrangement may include a 3-dimensional laser scanning apparatus and a camera, each configured to monitor an environment surrounding the vehicle.

The vehicle may also include an autonomous emergency braking (AEB) system configured to automatically apply brakes of the vehicle upon the detected presence of an object. In such an embodiment, the AEB system may include the sensor arrangement and the electronic controller.

The electronic controller may be in communication with an earth orbiting satellite and may be further configured to ascertain whether the vehicle is in motion via a signal received from the earth orbiting satellite.

The release system may additionally include a speed sensor in communication with the electronic controller and configured to detect a road speed of the vehicle. In such an embodiment the electronic controller may be further configured to ascertain whether the vehicle is in motion using a signal received from the speed sensor.

The mechanism may include a striker configured for engagement with a pivotable latch. In such an embodiment, the pivotable latch may include a primary catch portion configured to facilitate closure of the under-hood compartment via the hood panel, and a secondary catch portion configured to establish the second hood position.

The release system may additionally include an electromechanical device, such as a solenoid, in communication with the controller and configured to trigger the mechanism. Such triggering of the mechanism releases the primary catch portion from engagement with the striker and engages the secondary catch portion to establish the second hood position in response to the signal indicative of the detected presence of a vulnerable object.

The release system may additionally include a primary resilient element configured to urge the hood panel from the first hood position to the second hood position and a secondary resilient element configured to assist the primary resilient element in urging the hood panel from the first hood position to the second hood position when the controller triggers the mechanism.

The predetermined distance between the first hood position and the second hood position may be at least 10 mm.

The electronic controller may be further configured to trigger a sensory signal indicative of the hood panel having been released from the first hood position to the second hood position.

A method of controlling a release of a vehicle's hood panel from a first hood position to a second hood when the vehicle is in motion includes ascertaining, via an electronic controller, whether the vehicle is in motion, is also disclosed. The method also includes detecting, via a sensor arrangement in communication with the electronic controller, the presence of a vulnerable object in a path of the vehicle. The method additionally includes receiving, by the electronic controller from the sensor arrangement, a signal indicative of the detected presence of a vulnerable object. The method further includes triggering, via the electronic controller in response to the signal, a mechanism configured to selectively fasten the hood panel to the vehicle body such that the hood panel maintains closure of the compartment in a first hood position and maintain the hood panel within a predetermined distance from the vehicle body in a second hood position, to release the hood panel from the first hood position to the second hood position when the vehicle is in motion.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of a vehicle showing a partially sectioned hood panel and an under-hood compartment covered thereby, according to the disclosure.

FIG. 2 is a schematic close-up partial side view of the vehicle shown in FIG. 1, including a view of a mechanism configured to selectively fasten and release the hood panel to a body of the vehicle.

FIG. 3 is a schematic close-up perspective partial view of the vehicle shown in FIGS. 1 and 2 from the perspective of a vehicle fascia, including a view of a mechanism having a pivotable latch shown fastening the hood panel to a body of the vehicle in a first hood position.

FIG. 4 is a schematic close-up partial perspective view of the mechanism shown in FIG. 3, the mechanism depicted fastening the hood panel to the body of the vehicle in a second hood position.

FIG. 5 is a schematic close-up partial perspective view of the mechanism shown in FIG. 3, the mechanism depicted in the first hood position from the perspective of a vehicle passenger compartment.

FIG. 6 is a flow diagram of a method of controlling a release of a vehicle hood panel shown in FIGS. 1-5, according to the present disclosure.

### DETAILED DESCRIPTION

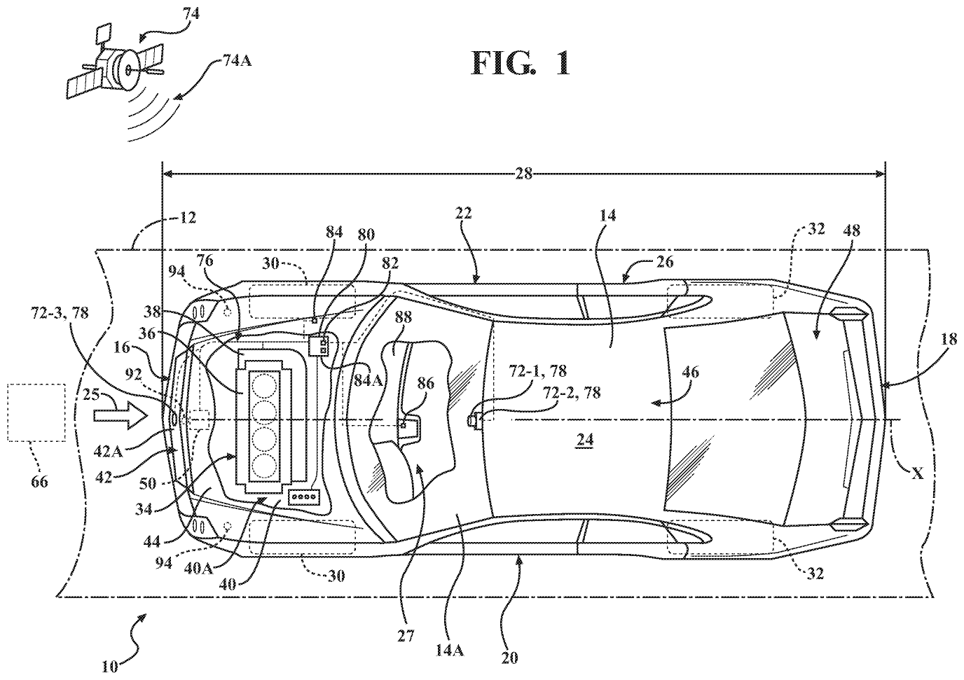

Referring to the drawings, wherein like reference numbers refer to like components, FIG. 1 shows a schematic view of a motor vehicle 10 positioned relative to a road surface 12. The vehicle 10 includes a vehicle body 14 having a longitudinal axis X. The vehicle body 14 generally defines six body sides. The six body sides include a first body end or front end 16, an opposing second body end or rear end 18, a left side or section 20, and a right side 22, a top body section 24, and an underbody section 26. The front end 16 is configured to face oncoming or incident, i.e., approaching and contacting, ambient airflow 25, for example, when the vehicle is in motion relative to the road surface 12. The vehicle body 14 also defines a passenger compartment 27.

Each of the left side, right side, top, and underbody body sections, 20, 22, 24, and 26, respectively, is configured to span a distance 28 between the front and rear ends 16, 18 of the body 14. As shown in FIG. 1, the vehicle 10 also includes a plurality of road wheels arranged between the first and second vehicle body ends 16, 18, proximate the left and right sides 20, 22, specifically front wheels 30 and rear wheels 32. The vehicle 10 also includes a powertrain 34 that includes a power-plant 36, such as an internal combustion engine (as shown) or a traction electric motor (not shown), for generating power-plant torque. The powertrain 34 may also include a transmission 38 operatively connecting the power-plant 36 to at least some of the road wheels 30, 32 for transmitting power-plant torque thereto and thereby put the vehicle 10 in motion.

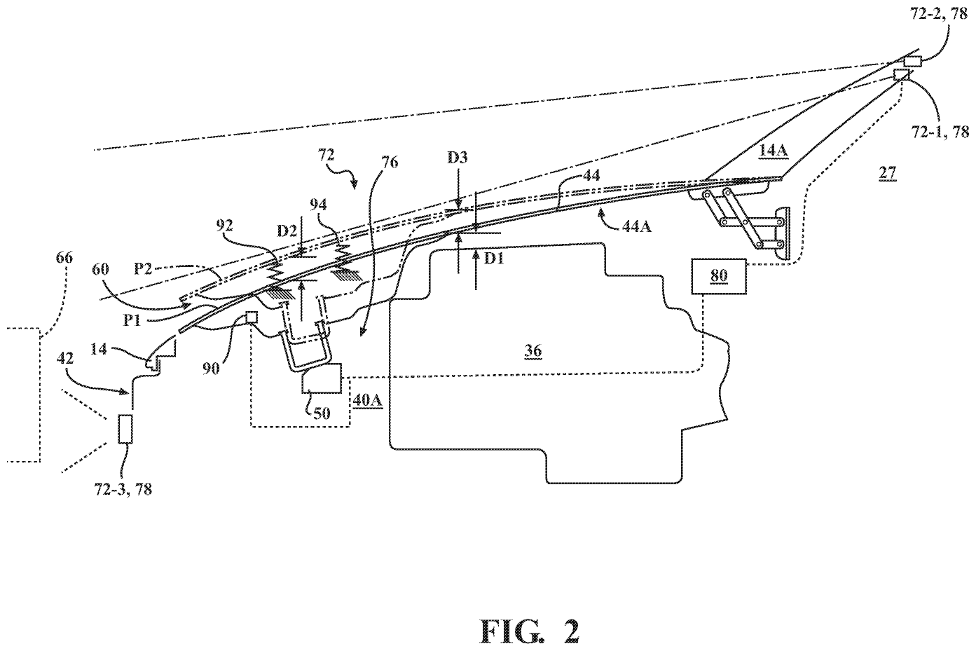

The vehicle body 14 defines a compartment 40 for housing the powertrain 34. As shown, the vehicle body 14 also includes a vehicle fascia 42 arranged at the front end 16. The fascia 42 defines an opening 42A configured to receive at least some of the oncoming ambient airflow 25, which may be used for cooling the powertrain 34. The vehicle 10 also includes a hood panel or bonnet 44 configured to cover the compartment 40 and thereby define an under-hood compartment 40A (shown in FIGS. 1 and 2) for housing the powertrain 34. The vehicle 10 may also include a vehicle roof 46 and a trunk lid 48. Although the powertrain 34 is shown as arranged proximate the front end 16, such that the vehicle 10 has a front-engine configuration, the powertrain 34 may, alternatively, be arranged proximate the rear end 18, such that the vehicle 10 has a mid- or rear-engine configuration. Corresponding to the specifically shown front-engine configuration of the vehicle 10, the hood panel 44 is depicted as arranged generally proximate the front end 16, while the trunk lid 48 is arranged generally proximate the rear end 18. As shown in FIG. 2, in the vehicle 10 having a front-mounted power-plant 36, with the hood panel in its fully-closed position, the power-plant resides at a distance D1 from an underside 44A of the hood panel 44. In the event of the vehicle's frontal, i.e., at the front end 16, high-energy impact with an object 66, the distance D1 provides space for the hood panel 44 to deflect before contacting the power-plant 36 and absorb a force of such an impact.

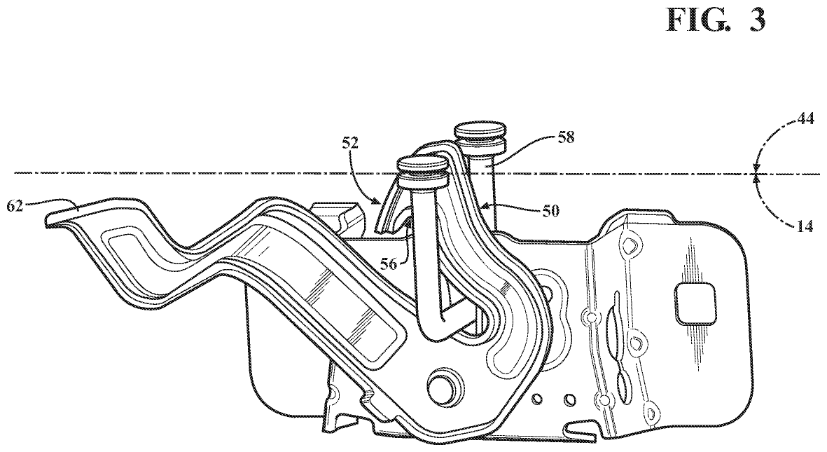

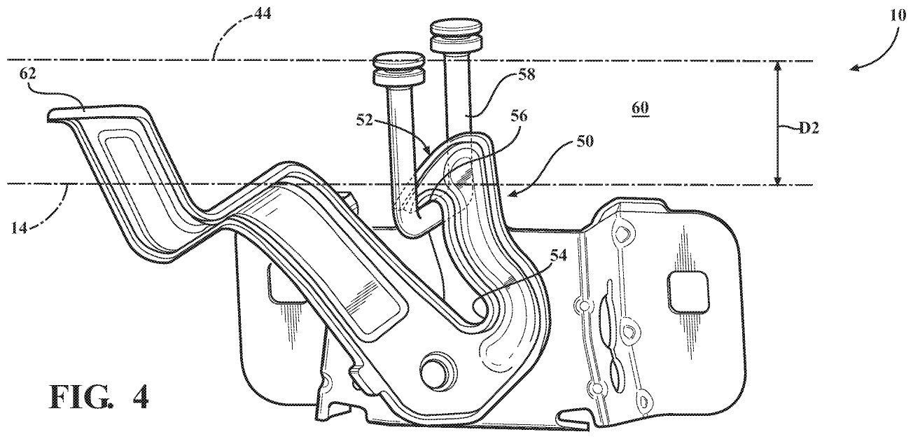

The vehicle 10 also includes a mechanism 50 (shown schematically in FIGS. 1 and 2, and in detail in FIGS. 3-5) configured to fasten the hood panel 44 to the vehicle body 14 such that the hood panel maintains closure of the compartment 40. Although the remainder of the present disclosure primarily concentrates on a front latching (shown in FIG. 1), i.e., proximate the fascia 42, hood panel 44, the present disclosure is similarly applicable to a rear latching (not shown), i.e., proximate the passenger compartment 27, hood panel. FIG. 3 illustrates the mechanism 50 from the perspective of the vehicle fascia 42. As shown in FIG. 3, the mechanism 50 includes a pivotable latch 52 having a primary catch portion 54 configured to facilitate or maintain closure of the under-hood compartment 40A via the hood panel 44 being pulled against the vehicle body 14 in a first hood position P1. The pivotable latch 52 also includes a secondary catch portion 56 configured to limit, such as constrain and/or maintain, the hood panel 44 within a substantially vertical predetermined distance D2 from the vehicle body 14 proximate the latch 52 area in a second hood position P2 (shown in FIGS. 2 and 4). Accordingly, the second hood position P2 and the first hood position P1 are separated by the predetermined distance D2. Such limiting of the position of the hood panel 44 by the secondary catch portion 56 within the predetermined distance D2 of the vehicle body 14 is typically configured to generate an opening 60 between the vehicle body and the hood panel. Additionally, and as a result of the hood panel 44 shifting from the first hood position P1 to the second hood position P2, the distance between the underside 44A of the hood panel 44 and the power-plant 36 will increase to a substantially vertical distance D3. Therefore, the second hood position P2 may establish an open space, defined by the distance D3, above the power-plant 36. The predetermined distance D2 may be at least 10 mm, and may be 27 mm or greater, such that, in an exemplary embodiment, for a hood panel 44 having an approximate length of 114 cm, the distance D3 may be 5 mm or greater.

As shown in FIGS. 3-5, the mechanism 50 additionally includes a striker 58 configured to cooperate with the latch 52. In an embodiment where the pivotable latch 52 is mounted to the vehicle body 14, the striker 58 may be fixed to the hood panel 44. Alternatively, where the pivotable latch 52 is mounted to the hood panel 44, the striker 58 may be fixed to the vehicle body 14. The position of the hood panel 44 is specifically limited to within the predetermined distance D2 by an engagement between the secondary catch portion 56 and the striker 58 (shown in FIG. 3). The predetermined distance D2 is generally configured to provided access to a release handle 62, which may be part of the pivotable latch 52 or otherwise located proximate the vehicle fascia 42. The release handle 62 is configured as a lever for shifting the secondary catch portion 56 out of position where it traps the striker 58. The previously described engagement between the secondary catch portion 56 and the striker 58 (shown in FIG. 3) also permits the release handle 62 to be exposed for access by an operator within the opening 60, such as a vehicle maintenance technician, and facilitate a release of the secondary catch portion 56 to uncover the under-hood compartment 40A via the hood panel 44. As may be seen in FIG. 3, the mechanism 50 also includes a first resilient element 64, such as a clock spring, configured to preload the pivotable latch 52 such that during respective engagement of the primary catch portion 54 and the secondary catch portion 56 each catch portion maintains contact with the striker 58.

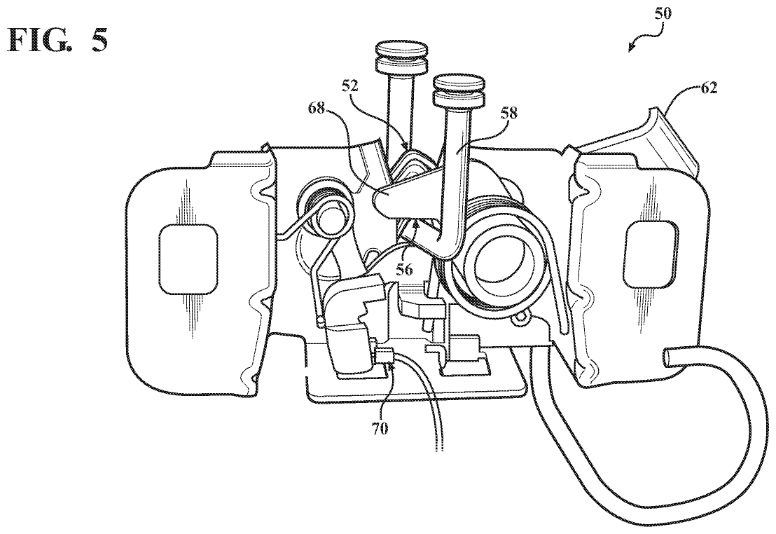

FIG. 5 illustrates the mechanism 50 from its backside, for example, from the perspective of the passenger compartment 27. As shown, the mechanism 50 may also include a fork bolt 68 configured to capture the striker 58 and thereby fasten the hood panel 44 to the vehicle body 14. The mechanism may 50 additionally include a device 70 configured to release the fork bolt 68. For example, as shown in FIG. 5, the device 70 may be a cable, lever with a catch, and/or a solenoid actuated by the operator of the vehicle 10. The release of the fork bolt 68 is intended to free the hood panel 44 for separation from the vehicle body 14 by the predetermined distance D2, and thereby establish the opening 60 between the vehicle body and the hood panel. Such release of the fork bolt 68 may be accomplished remotely from the vehicle's passenger compartment 27.

The vehicle 10 includes an autonomous emergency braking (AEB) system 72 configured to automatically apply brakes of the vehicle upon the detected presence of the object 66. The AEB system 72 may use camera 72-1, laser light imaging, detection, and ranging (LIDAR) 72-2, and all-weather radar 72-3, in a fusion of the three technologies to monitor their environment, i.e., surrounding the vehicle 10, and detect and identify potential threats to help the vehicle 10 avoid various types of road hazards. For example, LIDAR 72-2 measures distance to a target by illuminating the target with pulsed laser light and measuring the reflected pulses with a sensor. Differences in laser return times and wavelengths are then used to make digital 3-D representations of the target. The camera 72-1 complements the radar's ranging ability by enabling object detection and classification, and so adds to the overall performance capabilities of the AEB system 72. Camera 72-1 and LIDAR 72-2 sensors are generally mounted behind a windscreen 14A of the vehicle, and are therefore well protected. LIDAR 72-2 sensors typically clip onto the windscreen 14A for easy removal and re-fitment during windscreen replacement, while radar 72-3 sensor assemblies are frequently mounted directly to the vehicle body 14.

The AEB system 72 may further employ the above technologies together with image recognition to detect and identify impending impact with a particular object 66. Through the use of the above technologies, the AEB system 72 may specifically identify a vulnerable road user embodiment of the object 66, for example, a pedestrian, cyclist, or a large animal in the vehicle's path, as part of a more general collision avoidance or mitigation strategy. The AEB system 72 uses the above technologies together with image recognition software to detect an impending impact with a vulnerable road user. Complex algorithms are also used in analyzing sensor data to identify collision partners, and in conjunction with vehicle motion data determine their relative position, speed, and hence the collision threat. If a critical situation is identified and the vehicle 10 operator fails to react appropriately, the AEB system 72 may automatically apply the vehicle's brakes to avoid the collision altogether or lessen the impact. Teaming camera 72-1, LIDAR 72-2, and radar 72-3 sensors in “fusion” enables the AEB system 72 to specifically address collisions between the vehicle 10 and vulnerable road users. Vehicle Global Positioning System (GPS) sensors are also able to detect fixed, i.e., stationary, dangers in the moving vehicle's path such as approaching stop signs via an earth orbiting satellite 74, or a location database, such as on an IT cloud. The AEB system 72 is designed to prevent or reduce severity of a collision or impact between the vehicle 10 and the identified object 66.

As shown in FIGS. 1 and 2, the vehicle 10 also includes a release system 76 configured to regulate the mechanism 50 for releasing the hood panel 44 from the first hood position P1 to the second hood position P2. The release system 76 also includes a sensor arrangement 78 configured to monitor for and detect the presence of the vulnerable object 66, such as a pedestrian, cyclist, or large animal in a path of the moving vehicle 10 and an electronic controller 80 in electronic communication with the subject sensor arrangement. Each of the sensor arrangement 78 and the electronic controller 80 may be part of the AEB system 72. Consequently, the sensor arrangement 78 may include 3-dimensional laser scanning apparatus, such as the LIDAR 72-2 described above, and a camera, each configured to monitor an environment surrounding the vehicle 10. The electronic controller 80 may be an electronic control unit (ECU) for the vehicle 10 or a stand-alone controller. The controller 80 includes a memory that is tangible and non-transitory. The memory may be a recordable medium that participates in providing computer-readable data or process instructions. Such a medium may take many forms, including but not limited to non-volatile media and volatile media.

Non-volatile media used by the controller 80 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 80 may also include a flexible disk, hard disk, magnetic tape, other magnetic medium, a CD-ROM, DVD, other optical medium, etc. The controller 80 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 80 or accessible thereby may be stored in the memory and automatically executed to provide the required functionality.

The electronic controller 80 is configured, i.e., structured and programmed, to operate the release system 76, and may also be configured to operate the AEB system 72. Specifically, the electronic controller 80 is configured to ascertain whether the vehicle 10 is in motion. The electronic controller 80 is additionally configured to receive, from the sensor arrangement 78, a signal 82 indicative of the detected presence of a vulnerable object 66 in a path of the moving vehicle 10. The electronic controller 80 is further configured to trigger the mechanism 50, in response to the signal 82, to release the hood panel 44 from the first hood position P1 to the second hood position P2 when the vehicle 10 is in motion. The subject release of the hood panel 44 from the first hood position P1 to the second hood position P2 is intended to mitigate a high-energy impact of the vulnerable object 66 with the vehicle 10, specifically in the area of the hood panel 44 near the latch 52 and generally proximate the vehicle fascia 42. Additionally, release of the hood panel 44 to the second hood position P2 may mitigate a high-energy impact of the vulnerable object 66 with the hood panel 44 above the power-plant 36.

The controller 80 may be in electronic communication with the earth orbiting satellite 74, and be further configured to ascertain whether the vehicle 10 is in motion using a signal 74A received from the satellite. The vehicle 10 may additionally include a speed sensor 84 configured to detect a road speed of the vehicle. The speed sensor 84 may be used as part of the release system 76 in communication with the electronic controller 80, and the electronic controller may be further configured to ascertain whether the vehicle 10 is in motion using a signal 84A received from the speed sensor.

As shown in FIG. 5, the release system 76 additionally includes an electromechanical device, such as the solenoid embodiment of the device 70 configured to release the fork bolt 68. The electromechanical device 70 is in communication with the controller 80 and configured to trigger the mechanism 50 in response to the signal 82. Accordingly, upon receipt of the signal 82, the controller 80 triggers the electromechanical device 70, and thereby releases the primary catch portion 54 from engagement with the striker 58 to engage the secondary catch portion 56 and establish the second hood position P2. As shown in FIG. 1, the controller 80 may be further configured to trigger a sensory signal 86 or an alert indicative of the hood panel 44 having been released from the first hood position P1 to the second hood position P2. Such a signal 86 may be displayed on an instrument panel 88 of the vehicle 10 for alerting the vehicle operator. Additionally, the controller 80 may be configured to increase intensity of the signal 86, whether audibly or visually, in the event the vehicle 10 remains in motion following the release of the hood panel 44 from the first hood position P1 to the second hood position P2. The controller 80 may be further configured to ascertain or detect whether the hood panel 44 has been re-latched to the first hood position P1, for example, via a hood position sensor 90 (shown in FIG. 2).

With resumed reference to FIG. 2, the release system 76 may also include one or more primary resilient elements 92 configured to urge the hood panel 44 from the first hood position P1 to the second hood position P2, and maintain the hood panel 44 in the second position. The primary resilient element(s) 92 may be positioned proximate the fascia 42, either on the hood panel 44, such as adjacent the striker 58, or on the vehicle body 14, for example, adjacent the latch 52. Additionally, the release system 76 may include at least one secondary resilient element 94 configured to assist the primary resilient element 92 in urging the hood panel 44 from the first hood position P1 to the second hood position P2 when the controller 80 triggers the mechanism 50. The secondary resilient element(s) 94 may be positioned proximate the fascia 42 either on the hood panel 44 or on the vehicle body 14, along the side edge(s) of the hood panel 44. The secondary resilient element(s) 94 may be especially beneficial in accelerating deployment of the hood panel 44 upon the controller's receipt of the signal 82 indicative of the detected presence of a vulnerable object 66, as well as absorbing the force of a high-energy impact on the hood panel.

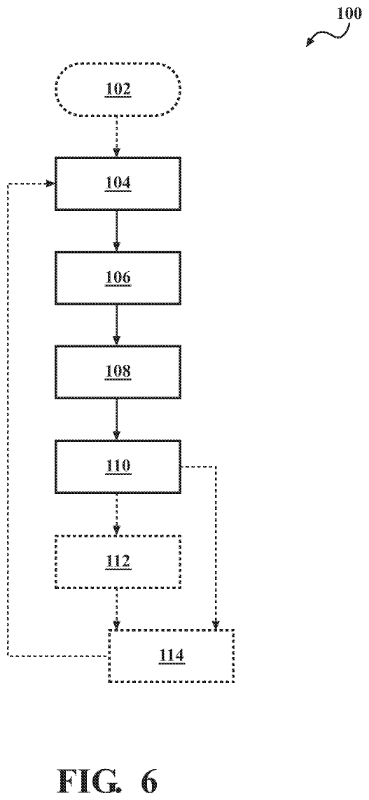

FIG. 6 depicts a method 100 of controlling a release of a vehicle hood panel 44, as described above with respect to FIGS. 1-5. Controlling the release of the hood panel 44 as detailed below is intended to reduce the magnitude of forces on the vulnerable object 66 in the event the object impacts the vehicle 10 in the area of the hood panel above the power-plant 36. The method 100 may initiate in frame 102 with ascertaining or detecting, whether the hood panel 44 is appropriately latched to the first hood position P1, for example, via the hood position sensor 90, shown in FIG. 2, following which the method would advance to frame 104. Alternatively, the method may initiate in frame 104. In frame 104, the method includes ascertaining, via the electronic controller 80, whether the vehicle 10 is in motion. The controller 80 may be configured to ascertain whether the vehicle 10 is in motion using the signal 74A received from the earth orbiting satellite 74. Alternatively, the controller 80 may be configured to ascertain whether the vehicle 10 is in motion using the signal 84A received from the speed sensor 84. Following frame 104, the method proceeds to frame 106.

In frame 106, the method includes monitoring for and detecting, via the sensor arrangement 78 in communication with the electronic controller 80, the presence of a vulnerable object 66 in the path of the vehicle 10. As described above with respect to FIGS. 1-5, the sensor arrangement includes camera 72-1 and 3-dimensional laser scanning, such as the LIDAR 72-2, each of the sensing devices configured to monitor the environment surrounding the vehicle 10, and which may be part of the autonomous AEB system 72. After frame 106, the method advances to frame 108. In frame 108, the method includes receiving, by the electronic controller 80 from the sensor arrangement 78, the signal 82 indicative of the detected presence of a vulnerable object 66. Following frame 108, the method proceeds to frame 110.

In frame 110 the method includes triggering, via the electronic controller 80 in response to the signal 82, the mechanism 50 to release the hood panel 44 from the first hood position P1 to the second hood position P2 when the vehicle 10 is in motion. After frame 110, the method may advance to frame 112. In frame 112 the method includes triggering, via the electronic controller 80, a sensory signal 86 indicative of the hood panel 44 having been released from the first hood position P1 to the second hood position P2. Following either frame 110 or frame 112, the method may proceed to frame 114 for ascertaining or detecting whether the hood panel 44 has been re-latched to the first hood position P1, for example, via the hood position sensor 90, as described above with respect to FIG. 2. After frame 114, the method may return to frame 104 for ascertaining, via the electronic controller 80, whether the vehicle 10 is in motion and proceed with monitoring and detecting, via the sensor arrangement 78, the presence of a vulnerable object 66 in the path of the vehicle 10.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A vehicle comprising:
a vehicle body defining a compartment;
a hood panel configured to cover the compartment and thereby define an under-hood compartment;
a mechanism configured to selectively fasten the hood panel to the vehicle body such that the hood panel maintains closure of the compartment in a first hood position and maintains the hood panel within a predetermined distance from the vehicle body in a second hood position; and
a release system configured to regulate the mechanism to release the hood panel from the first hood position to the second hood position, including:
a sensor arrangement configured to detect the presence of a vulnerable object in a path of the vehicle; and
an electronic controller configured to:
ascertain whether the vehicle is in motion;
receive, from the sensor arrangement, a signal indicative of the detected presence of a vulnerable object; and
trigger the mechanism, in response to the signal, to release the hood panel from the first hood position to the second hood position when the vehicle is in motion.

2. The vehicle of claim 1, wherein the sensor arrangement includes a 3-dimensional laser scanning apparatus and a camera, each configured to monitor an environment surrounding the vehicle.

3. The vehicle of claim 1, further comprising an autonomous emergency braking (AEB) system configured to automatically apply brakes of the vehicle upon the detected presence of an object, wherein the AEB system includes the sensor arrangement and the electronic controller.

4. The vehicle of claim 1, wherein the electronic controller is in communication with an earth orbiting satellite and is further configured to ascertain whether the vehicle is in motion using a signal received from the earth orbiting satellite.

5. The vehicle of claim 1, wherein the release system additionally includes a speed sensor in communication with the electronic controller and configured to detect a road speed of the vehicle, and wherein the electronic controller is further configured to ascertain whether the vehicle is in motion using a signal received from the speed sensor.

6. The vehicle of claim 1, wherein the mechanism includes a striker configured for engagement with a pivotable latch, and wherein the pivotable latch includes:
a primary catch portion configured to facilitate closure of the under-hood compartment via the hood panel; and
a secondary catch portion configured to establish the second hood position.

7. The vehicle of claim 6, wherein the release system additionally includes an electromechanical device in communication with the electronic controller and configured to trigger the mechanism, and thereby release the primary catch portion from engagement with the striker and engage the secondary catch portion to establish the second hood position in response to the signal indicative of the detected presence of a vulnerable object.

8. The vehicle of claim 1, wherein the release system additionally includes a primary resilient element configured to urge the hood panel from the first hood position to the second hood position and a secondary resilient element configured to assist the primary resilient element in urging the hood panel from the first hood position to the second hood position when the controller triggers the mechanism.

9. The vehicle of claim 1, wherein the predetermined distance between the first hood position and the second hood position is at least 10 mm.

10. The vehicle of claim 1, wherein the electronic controller is further configured to trigger a sensory signal indicative of the hood panel having been released from the first hood position to the second hood position.

11. A method of controlling a release of a hood panel of a vehicle having a vehicle body defining a compartment, and wherein the hood panel is configured to cover the compartment and thereby define an under-hood compartment, the method comprising:
ascertaining, via an electronic controller, whether the vehicle is in motion;
detecting, via a sensor arrangement in communication with the electronic controller, the presence of a vulnerable object in a path of the vehicle;
receiving, by the electronic controller from the sensor arrangement, a signal indicative of the detected presence of a vulnerable object; and
triggering, via the electronic controller in response to the signal, a mechanism configured to selectively fasten the hood panel to the vehicle body such that the hood panel maintains closure of the compartment in a first hood position and maintains the hood panel within a predetermined distance from the vehicle body in a second hood position, to release the hood panel from the first hood position to the second hood position when the vehicle is in motion.

12. The method of claim 11, wherein the sensor arrangement includes a 3-dimensional laser scanning apparatus and a camera, further comprising monitoring an environment surrounding the vehicle via each of the 3-dimensional laser scanning apparatus and the camera.

13. The method of claim 11, wherein the vehicle additionally includes an autonomous emergency braking (AEB) system configured to automatically apply brakes of the vehicle upon the detected presence of an object, and wherein the AEB system includes the sensor arrangement and the electronic controller.

14. The method of claim 11, wherein the electronic controller is in communication with an earth orbiting satellite, further comprising ascertaining, via the electronic controller using a signal received from the earth orbiting satellite, whether the vehicle is in motion.

15. The method of claim 11, wherein the release system additionally includes a speed sensor in communication with the electronic controller, further comprising detecting via the speed sensor a road speed of the vehicle and ascertaining, via the electronic controller using a signal received from the speed sensor, whether the vehicle is in motion.

16. The method of claim 11, wherein the mechanism includes a striker configured for engagement with a pivotable latch, and wherein the pivotable latch includes:
a primary catch portion configured to facilitate closure of the under-hood compartment via the hood panel; and
a secondary catch portion configured to establish the second hood position.

17. The method of claim 16, wherein the release system additionally includes an electromechanical device in communication with the electronic controller, further comprising triggering the mechanism, via the electromechanical device, to thereby release the primary catch portion from engagement with the striker and engage the secondary catch portion to establish the second hood position in response to the signal indicative of the detected presence of a vulnerable object.

18. The method of claim 11, wherein the release system additionally includes a primary resilient element and a secondary resilient element, further comprising urging the hood panel from the first hood position to the second hood position via the primary resilient element and assisting the primary resilient element with the secondary resilient element to urge the hood panel from the first hood position to the second hood position when the controller triggers the mechanism.

19. The method of claim 11, wherein the predetermined distance between the first hood position and the second hood position is at least 10 mm.

20. The method of claim 11, further comprising triggering, via the electronic controller, a sensory signal indicative of the hood panel having been released from the first hood position to the second hood position.
